(19) United States
(12) Patent Application Publication
(10) Pub. No.: US 2011/0131146 A1
(43) Pub. Date: Jun. 2, 2011

(54) Employment management system

(76) Inventor: Anthony John Skutnik, Tuxedo Park, NY (US)

(21) Appl. No.: 12/959,361

(22) Filed: Dec. 2, 2010

Related U.S. Application Data
(60) Provisional application No. 61/265,853, filed on Dec. 2, 2009.

(51) Int. Cl. G06Q 10/00

(52) U.S. Cl. 705/321

(57) ABSTRACT

Embodiments of the present disclosure generally relate to a system, apparatus, and computer program product for employment management and, more particularly, an automated system for managing and matching employment requirements and employment candidates physically separated from one another.

### CLAIM OF PRIORITY

This application claims the benefit of priority from U.S. Provisional Patent Application Ser. No. 61/265,853 filed on Dec. 2, 2009 and entitled “Metrics driven personnel assessments and interview capture”, which is fully incorporated herein by reference for all purposes.

### FIELD

Certain embodiments of the present disclosure generally relate to a system, apparatus, and computer program product for employment management and, more particularly, an automated system for managing and matching employment requirements and employment candidates.

### BACKGROUND

A process of matching employment requests and corresponding requirements with employment candidates is not novel, yet it has traditionally consisted of several manually performed work flows. For example, when a project manager at a company needs a new employee a request must be submitted to one or more approvers. If approved, HR may place a job opening on the company's website, in a local paper, or with a recruiting agency. Resumes of the candidates are then collected and forwarded to a reviewer, who subsequently selects a subset to send to one or more interviewers, which may include the request submitting project manager. After interviewing the candidates, one is selected and HR begins onboarding the selected candidate.

Each step of the preceding process may involve one or more workflows performed by a plurality of individuals from a plurality of groups from one or more organizations. Moreover, each individual, group, or organization may have different protocols, forms, and timelines. Consequently, the task of filling an Employment Request, or “Requirement,” may be unnecessarily complicated and delayed.

### SUMMARY

Certain embodiments provide an automation system for managing workflows associated with matching employment requirements and employment candidates. The system generally includes a set of databases, a user interface allowing a first user to create an employment requirement listing one or more qualifications for the requirement and store the requirement in a first database of the set of databases, a second user, physically separated from the first user, the ability to approve the employment requirement, a separate and distinct set of users, physically separated from the first and second users, the ability to enter data reflecting skills and qualifications and store it in a second database of the set of databases, and a third user the ability to search the first and second databases in an attempt to match one or more members of the separate and distinct set of users with at least one of the one or more qualifications of the employment requirement, and a communication protocol allowing the third user to communicate with any of the first user, second user, and separate and distinct set of users.

### BRIEF DESCRIPTION OF THE DRAWINGS

So that the manner in which the above-recited features of the present disclosure can be understood in detail, a more particular description, briefly summarized above, may be had by reference to embodiments, some of which are illustrated in the appended drawings. It is to be noted, however, that the appended drawings illustrate only certain typical embodiments of this disclosure and are therefore not to be considered limiting of its scope, for the description may admit to other equally effective embodiments.

FIG. 1 is a block diagram of a network illustrating the communication relationships between a plurality of users of embodiments of the present disclosure.

FIG. 2 is a block diagram illustrating a plurality of steps in an exemplary process of matching employment requirements with employment candidates.

FIG. 3 illustrates an exemplary workflow surrounding an Requirement in accordance with embodiments of the present disclosure.

FIG. 4 illustrates an exemplary workflow surrounding the posting of a job opening and selection of candidates for review in accordance with embodiments of the present disclosure.

FIG. 5 illustrates an exemplary electronic Requirement form in accordance with embodiments of the present disclosure.

FIG. 6 illustrates example soft skills which may be included as requirements within an exemplary Requirement.

FIG. 7 illustrates an exemplary dashboard interface in accordance with embodiments of the present disclosure.

### DETAILED DESCRIPTION

An automated employment management system can streamline and coordinate the plurality of workflows surrounding the process of matching employment requests and corresponding requirements with employment candidates. Consequently, employment requests, or “Requirements,” can be properly filled in a straightforward and expedited fashion.

Embodiments of the present disclosure, collectively referred to as the Vettex system, are multi-use automation tools used primarily for staffing. The core functionality is based on standard vendor management systems yet the functionality of embodiments of the present disclosure have been expanded greatly to function in between vendor management office (VMO), Job Board, and Social Networking protocols.

### An Example Employment Management System

In the following, reference is made to embodiments of the present disclosure. However, it should be understood that the present disclosure is not limited to specific described embodiments. Instead, any combination of the following features and elements, whether related to different embodiments or not, is contemplated to implement and practice the present disclosure. Furthermore, in various embodiments the disclosure provides numerous advantages over the prior art. However, although embodiments of the disclosure may achieve advantages over other possible solutions and/or over the prior art, whether or not a particular advantage is achieved by a given embodiment is not limiting of the disclosure. Thus, the following aspects, features, embodiments and advantages are merely illustrative and are not considered elements or limitations of the appended claims except where explicitly recited in a claim(s). Likewise, reference to “the present disclosure” shall not be construed as a generalization of any inventive subject matter disclosed herein and shall not be considered to be an element or limitation of the appended claims except where explicitly recited in a claim(s).

One embodiment of the present disclosure is implemented as a program product for use with a computer system. The program(s) of the program product defines functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive and DVDs readable by a DVD player) on which information is permanently stored; and (ii) writable storage media (e.g., floppy disks within a diskette drive, a hard-disk drive or random-access memory) on which alterable information is stored. Such computer-readable storage media, when carrying computer-readable instructions that direct the functions of the present disclosure, are embodiments of the present disclosure. Other media include communications media through which information is conveyed to a computer, such as through a computer or telephone network, including wireless communications networks. The latter embodiment specifically includes transmitting information to/from the Internet and other networks. Such communications media, when carrying computer-readable instructions that direct the functions of the present disclosure, are embodiments of the present disclosure. Broadly, computer-readable storage media and communications media may be referred to herein as computer-readable media.

In general, the routines executed to implement the embodiments of the disclosure, may be part of an operating system or a specific application, component, program, module, object, or sequence of instructions. The computer program of the present disclosure is typically comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the disclosure. However, it should be appreciated that any particular program nomenclature that follows is used merely for convenience, and thus embodiments should not be limited to use solely in any specific application identified and/or implied by such nomenclature.

A client system may generally include a central processing unit (CPU) connected by a bus to memory and storage. Each client system is typically running an operating system configured to manage interaction between the computer hardware and the higher-level software applications running on the client system. The server system may include hardware components similar to those used by the client system (e.g., a CPU, a memory, and a storage device, coupled by a bus). However, such a network environment is merely an example of one computing environment. Embodiments of the present disclosure may be implemented using other environments, regardless of whether the computer systems are complex multi-user computing systems, such as a cluster of individual computers connected by a high-speed network, single-user workstations, or network appliances lacking non-volatile storage. Further, embodiments of the disclosure may be implemented using computer software applications executing on existing computer systems, e.g., desktop computers, server computers, laptop computers, tablet computers, and the like. However, the software applications described herein are not limited to any currently existing computing environment or programming language, and may be adapted to take advantage of new computing systems as they become available.

While embodiments of the disclosure may be susceptible to various modifications and alternative forms, specific embodiments thereof are shown by way of example in the drawings and will herein be described in detail. The drawings may not be to scale. It should be understood, however, that the drawings and detailed description thereto are not intended to limit embodiments to the particular form disclosed, but to the contrary, the intention is to cover all modifications, equivalents, and alternatives falling within the spirit and scope of the present disclosure as defined by the appended claims.

Further modifications and alternative embodiments of various aspects of the disclosure will be apparent to those skilled in the art in view of this description. Accordingly, this description is to be construed as illustrative only and is for the purpose of teaching those skilled in the art the general manner of carrying out the embodiments of the disclosure.

It is to be understood that the forms of the disclosure shown and described herein are to be taken as examples of embodiments. Elements and materials may be substituted for those illustrated and described herein, parts and processes may be reversed, and certain features of the disclosure may be utilized independently, all as would be apparent to one skilled in the art after having the benefit of this disclosure. Changes may be made in the elements described herein without departing from the spirit and scope of the disclosure as described in the following claims.

Embodiments of the disclosure provide systems, apparatus, and computer program products to manage workflows surrounding the process of matching Requirements with employment candidates by functioning in between vendor management office (VMO), Job Board, and Social Networking protocols.

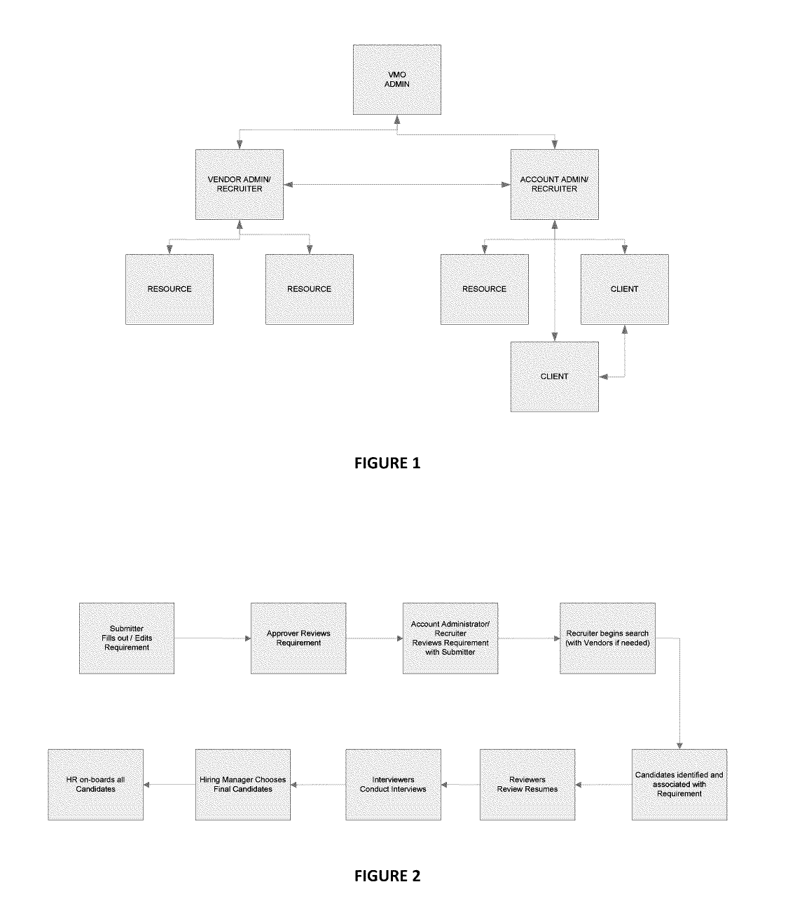

The functionality provided by the disclosure may operate with or be embodied in other systems as well. FIG. 1 is just one exemplary embodiment. Embodiments of the Employment Management System supply the functionality according to principles of the disclosure and may be implemented as one or more respective software modules operating on one or more suitable computers. A suitable computer typically comprises a processing unit, a system memory which might include both temporary random access memory and more permanent storage such as a disk drive, and a system bus that couples the processing unit to the various components of the computer.

Moreover, FIG. 1 is a block diagram illustrating the communication relationships between a plurality of users of a network. At the top of the diagram is a block 110 representing a VMO administrator. A VMO administrator is a Vettex employee assigned to an account (i.e., a company for which Vettex is working or on whose system the VETTEX system is installed). Above the VMO administrator is a Vettex administrator (not shown) employed by Vettex with broad control of and vision into the comprehensive Vettex database of all accounts, resources, clients, etc.

Below the VMO administrator are account administrators/recruiters 120 and vendor administrators/recruiters 130. A vendor in the VETTEX system is a firm representing and submitting resources, or individuals available to be placed on assignment, to Vettex, e.g. Accenture, Wipro. Each account or vendor in the VETTEX system may initially apply to Vettex through a web interface by completing a Vendor Profile Administration form. When an account or vendor makes an initial request for a Vettex profile they must identify a primary contact as the Account/Vendor Administrator 120/130. This user will be the sole contact for all administration issues when the account/vendor begins using the VETTEX system.

When an account or vendor is accepted by the Vettex administrator they are automatically identified as a vendor or account firm and must then assign a Recruiter, who will be the singular interface between the account or vendor and any other accounts or vendors. Each account and vendor may only assign one recruiter, and the Account/Vendor Administrator is responsible for updating any changes to those assignments.

Under the vendor administrator/recruiter 130 are resources 140. As previously described vendors in the VETTEX system are firms representing and submitting resources to Vettex, e.g. Accenture, Wipro. Accordingly, downstream users of embodiments of the VETTEX system may be individual available to be placed on assignment. Resources 140 may also be considered candidates while being considered for an assignment. Resources can be entered into the VETTEX system in two ways (by a Vendor or by themselves), but both are done through the Resource submission screen. This process should flag the person as a Resource. All Web user ID's are considered Resources. Within the Account full time employees are considered Clients, and temporary staff are Resources. The Account must provide this information during the implementation of the VETTEX system to establish the baseline staff. Once the VETTEX system is in place the Client/Resource status is determined by the Requirement. VMO Admin would flag these profiles if they must be done manually.

Under the Account Administrator/Recruiter 120 are clients 122. Clients 122 may be employees of an account e.g., submitters, approvers, reviewers, and interviewers. In some instances, resources 140 may apply directly to an account recruiter 120. Consequently, resources 140 may also be downstream of Account Administrators/Recruiters 120 and not just Vendor Administrators/Recruiters 130.

Embodiments of the present disclosure may be utilized to streamline and coordinate among the previously described users the plurality of workflows surrounding the process of matching Requirements with resources. FIG. 2 is a block diagram illustrating a plurality of steps in an exemplary simplified process 200 of matching employment requirements with employment resources 140.

The process 200 begins, at step 210, with a first client 122 submitting a Requirement. The client 122 submitting a Requirement for approval, normally (but not always) the hiring manager, may be referred to as the Submitter. Moreover, there may be only one Submitter per Requirement. Requirement submissions may utilize a Requirement Wizard including the screens and forms used by the submitter to put defined employment requirements into the VETTEX system. At the conclusion of the Requirement submission a requirement summary may be displayed providing a single screen summary of the employment requirements to be used for future reference.

At step 220, a second client 122 receives the Requirement for review and approval and may be referred to as the Approver. The Approver may be assigned by the submitter while completing the Requirement form. In certain situations, there may be multiple Approvers for a single Requirement.

After being approved by each identified Approver, the Account Administrator/Recruiter 120 reviews the Requirement with the Submitter, at step 230. At step 240, the Recruiter begins a search for resources to fill the Requirement. In some instances, the Account Recruiter may find a sufficient pool of candidates for the Requirement from resources already on file with the account, while in other instances the account recruiter may look to a vendor recruiter to find a sufficient pool of candidates for the Requirement.

At step 250, candidates are identified by the Account Recruiter and associated with the Requirement. At step 260, the profiles of the candidates are forwarded by the Account Recruiter to a client 122 for review. The client 122 receiving the candidate profiles submitted against a Requirement may be referred to as a Reviewer. The Reviewers may be assigned by the Submitter while completing the requirement form. As with Approvers, there may be multiple Reviewers for each Requirement. In some instances, the Reviewer may be the same individual previously referred to as the Submitter or Approver, while in other instances the reviewer may be a third client.

After the Reviewers are done reviewing the candidate profiles, a subset of those profiles is forwarded to Interviewers for candidate interviews, at step 270. The Interviewers are clients which may be assigned by the Submitter while completing the requirement form. Moreover, as was described with respect to Approvers, multiple Interviewers may be assigned for each Requirement and the Interviewers may be the same clients that performed other, previously described, roles.

At step 280, the results of the Interviewers along with the candidate profiles may be forwarded to a Hiring Manager for selection of the candidate to fill the Requirement. In some instances the Hiring Manager may select more than one candidate to fill a single Requirement. At step 290, Human Resources (HR) on-boards all candidates selected by the Hiring Manger. HR may include a Human Resources Person working at/for the Account, that is responsible for on-boarding and any needed client interface with a Candidate/Resource.

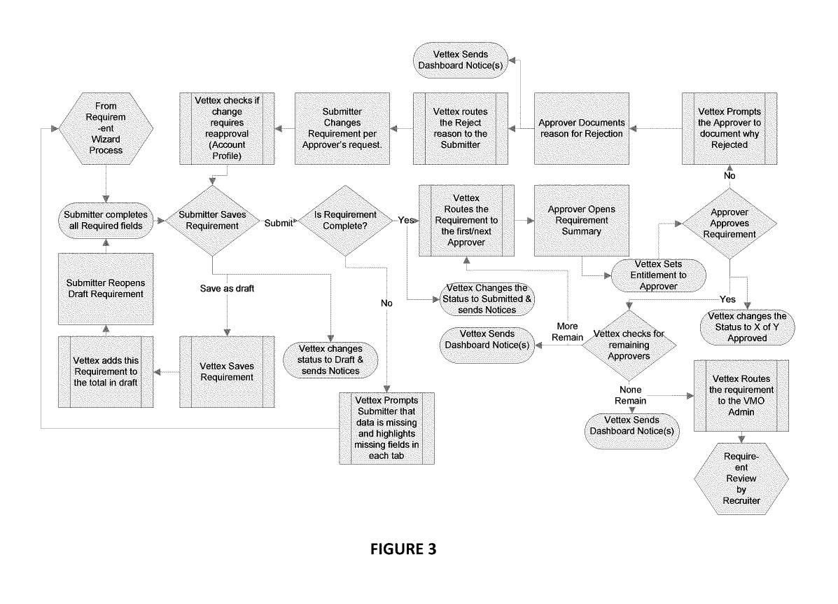

FIG. 3 illustrates an exemplary workflow surrounding the submission of a Requirement 210 and the subsequent Approver review 220 which is automated by embodiments of the present disclosure. The exemplary workflow illustrated in FIG. 3 begins with the Submitter interfacing with an employment request, or Requirement, wizard, at step 300. After the Submitter completes all required fields 302 of the Requirement wizard, the Submitter may submit the Requirement after saving it 304. If the Requirement is complete 306, the VETTEX system routes the Requirement to the first/next Approver 308. At 310, the Approver opens the Requirement summary and the VETTEX system sets the entitlement corresponding to the Requirement to “Approver” 312. Assuming the Approver approves the Requirement 314, the VETTEX system changes the status of an “X of Y approved” field 316 and checks for remaining Approvers mandated by the Requirement 318. If no additional Approvers are mandated, the VETTEX system sends dashboard notices to the appropriate clients 320 and routes the Requirement to the Account administrator/Recruiter 120.

However, if the workflow exceeds a single iteration of drafting, then the workflow surrounding the submission of a Requirement 210 and the subsequent Approver review 220 continues. For example, if the Submitter does not submit the Requirement after saving it 304, then the VETTEX system saves the requirement 332, changes the status of the Requirement to “Draft,” and sends notices 330 to the appropriate clients 122. The VETTEX system then adds this Requirement to the list of requirements with “Draft” statuses 334 until the Submitter reopens the Requirement 336 and completes all the required fields 302.

Similarly, if the Approver does not approve the Requirement 314 on the first pass, then the workflow surrounding the submission of a Requirement 210 and the subsequent Approver review 220 again continues. For example, if the Approver does not approve the Requirement 314 on the first pass then the VETTEX system prompts the Approver to document the reason for rejecting the Requirement 340. After the Approver documents the reason for Rejection 342, then the VETTEX system sends a Dashboard Notice(s) 344 to the appropriate clients and routes the reject reason to the Submitter 346. In response, the Submitter may change the Requirement in accordance with the Approvers request 348, and the VETTEX system checks to see if the changes require re-approval based on the account profile 350. Either way, the Submitter saves the amended Requirement, thereby reentering the workflow at 304.

Whether embodiments of the present disclosure are employed or not, the preceding workflow would be substantially similar. However, the Submitter would have to manually forward the Requirement to the Approver, mentally retain the status of this Requirement amid the host of other duties expected of him, and remember where a draft of the Requirement was saved should the Approver reject the initial submission.

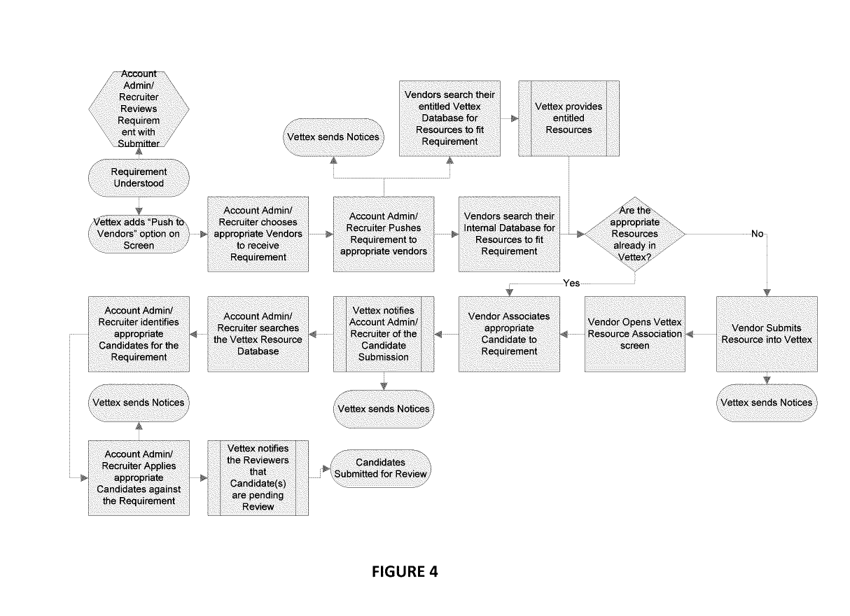

Similarly, FIG. 4 illustrates an exemplary workflow surrounding the posting of a job opening and selection of candidates for review in accordance with embodiments of the present disclosure. As in FIG. 3, whether embodiments of the present disclosure are employed or not, the workflow would be substantially similar. However, the Account Administrator/Recruiter would have to manually forward the requirement to one or more selected vendors. Vendors, in turn, would have to search their internal databases to compiles a pool of potential candidates. The profiles of the resulting pool of candidates would then have to be copied physically or electronically and forwarded to the Account Administrator/ Recruiter. Consequently, if the Account Administrator/ Recruiter forwarded the Requirement to more than one Vendor, the multiple candidates pools and the corresponding candidate profiles would have to be collected, reviewed, and forwarded either manually or electronically to the clients of the account involved the selection process.

### Exemplary Requirement Form

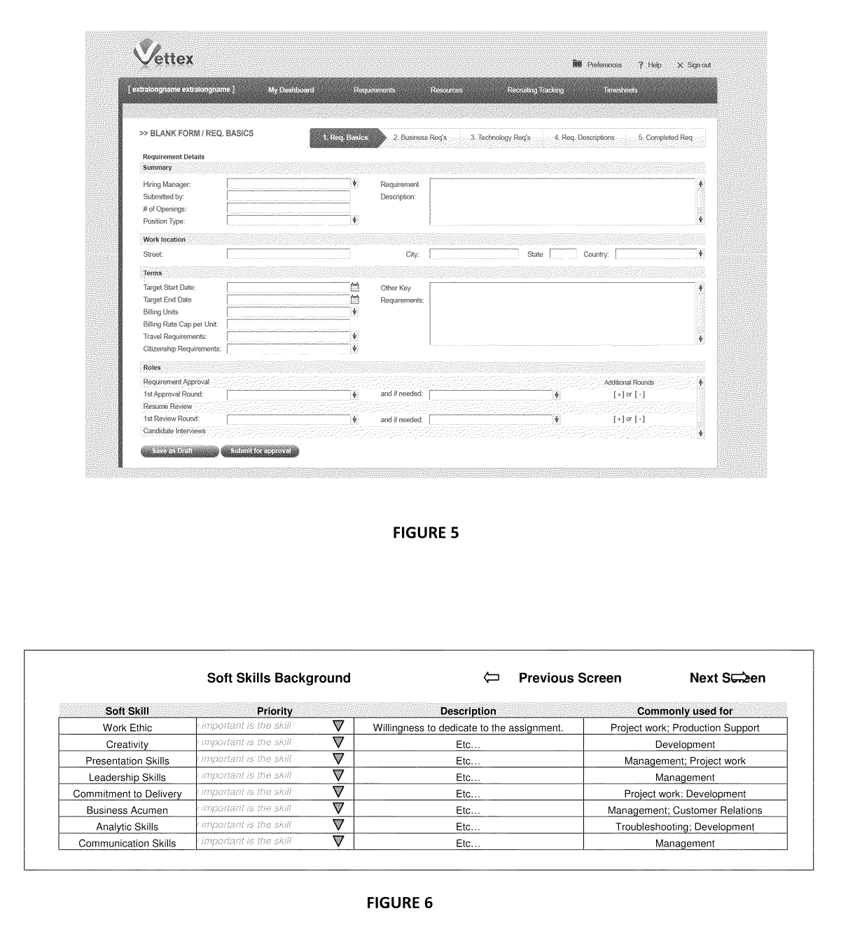

FIG. 5 illustrates an exemplary electronic Requirement form in accordance with embodiments of the present disclosure. As with a conventional Requirement form, the name of the Hiring Manager and Submitter, as well as, the job description, number of openings, position type, position description, location of position, targeted start date, salary, etc. Additionally, embodiments of the present disclosure may include the ability to identify and describe soft skills (e.g., work ethic, creativity, presentation skills, leadership skills, etc.) necessary under the Requirement. FIG. 6 illustrates example soft skills which may be included as qualifications within an exemplary Requirement.

Though previously described as the forwarding of candidate profiles, embodiments of the present disclosure do not require a first client to hand over physical documents, nor proactively forward via email any electronic documents to the subsequent client in the process.

Instead embodiments of the present disclosure utilize email and social networking protocols to generate automated notifications which may be sent to the subsequent client in the process as defined by the roles assigned by the Requirement Submitter. The email may contain hyperlinks sending the subsequent client to the VETTEX system login page. Once logged in, the client will be taken to a page displaying a dashboard interface summarizing important information relevant to the client within the VETTEX system.

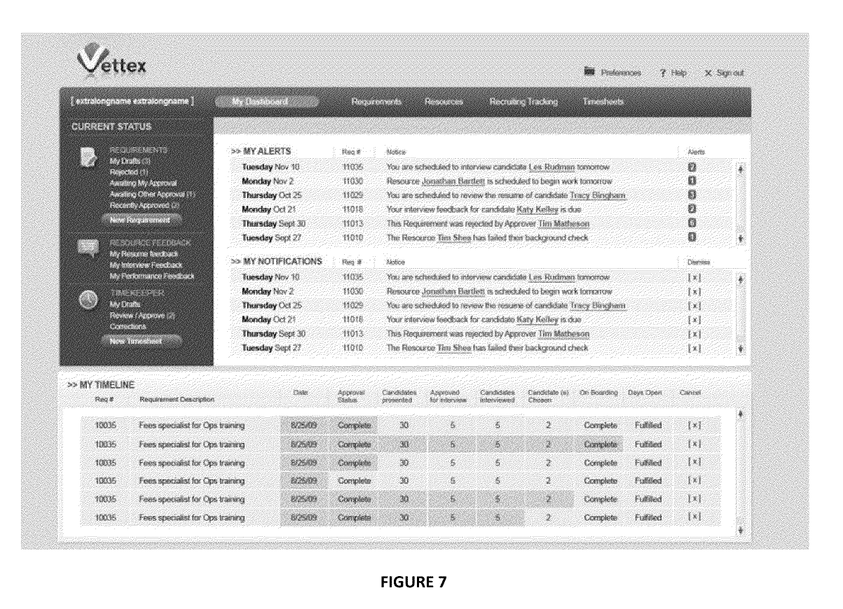

FIG. 7 illustrates an exemplary dashboard interface 700 in accordance with embodiments of the present disclosure. The central user experience is a single page user Dashboard, which shows the summary default screen that displays all action, notification and/or status information entitled to the individual accessing the VETTEX system. The Dashboard page will be the primary “one stop” for all key information for the user, serving both as a portal to all supporting screens and a summary status for all information important to the user.

Since there are different user types there may be different dashboard layouts and data. User access and viewable data on the Dashboard will be controlled by one or more entitlement protocols, with each user able to see only that data relevant (entitled) to them.

In embodiments of the present disclosure, the dashboard interface 700 may include a view of current alerts 710 and notifications 720 associated with the client in the VETTEX system. Further, the timeline 730 will provide a visual status summary of each open Requirement to help the user easily track progress. In addition, the dashboard interface 700 may readily make available access to every Requirement associated with the client via one or more hyperlinks (e.g., the “REQUIREMENTS” banner 740 or the “REQUIREMENTS” tab 752 located at the top of the page. Moreover, the dashboard interface 700 may enable the client to readily access information on current and previous resources via one or more hyperlinks (e.g., the “RESOURCE FEEDBACK” banner 750 or the “RESOURCES” tab 754).

Generally, users are sent alerts when the user has some action pending that others are waiting for, normally as part of the Requirement fulfillment process, while notifications are sent when the user has some vested interest in some action or status change that was posted in the VETTEX system.

In some embodiments, alerts may update the status bar since alerts require some action to be taken. Moreover, some issues may be an alert for one user and a notification for another, but a single issue cannot be both an alert and a notification for the same user. An alert can automatically dismissed (and thereby removed from the dashboard) only when the user takes an action on it. However, notifications remain on the dashboard for 30 days, or until the user clicks the Dismiss button.

Examples of notices which may appear as current alerts 710 or notifications 720, may include an alert to the Vettex Admin that “(Vendor) has requested to participate in Vettex. Please review their application,” when a Vendor has submitted an application to Vettex. Other examples, may include: an Email and Notification to the Vendor admin that “(Vendor) has been approved to participate in Vettex,” when a Vendor has been approved by Vettex; an alert to the Vendor Admin that: “(Vendor) has been added as a (tier level) vendor for (Account). Please assign a Recruiter using your Vendor Account admin screen,” When an Account has been added to the Vendor Account list; or a notification to the VMO admin that: “(Vendor) has assigned (Recruiter) to this Account,” when a Recruiter has been assigned to an Account.

In certain embodiments, actions that create a user alert may also send an email prompt to the same recipient. The email may include a link to bring the user to the login screen, or the dashboard if the user is already logged in. Users may also receive email for Notifications if the setting is changed in their Preferences menu.

As described above, each Requirement moves through a multi-step process while it is being fulfilled. The timeline 730 will provide a visual status summary of each open Requirement to help the user easily track progress. If a Requirement is closed or rejected it does not appear in the Timeline. The stages on the timeline and the logic for the text and/or values in each field are described below. All of the actions that impact the timeline will also create a Notice.

The first stage on the timeline 730 is the Approval stage. The status if the Approval stage for an item can never be blank since the timeline 730 shows only those Requirements that are in the process of being fulfilled and approvals are the first step in that process. Values for this field will either be a number “X of Y Pending” or “Complete.” The number of Approvals collected vs. the total Approvals needed should be shown, for example, if 3 Approvals were required (per the Requirement) and only the first one is complete the Approval stage field would read “2 of 3 Pending”. Once all Approvals are complete and the Requirement is ready to move to the next stage in the timeline, the Approval stage field would read “Complete.” In certain embodiments, the “X of Y” or “Complete” text may be hyperlinked to the full list of the required Approvals/Review/Interviews for that given stage.

The second stage on the timeline 830 is the Candidates Being Vetted stage. These are the candidates that the Vendors have applied to the Requirement and, therefore, are being considered for the request. All candidates in this list must be reviewed by the Account administrator and either approved for client review or rejected (per a Candidate Presented feedback form). If approved the candidate moves into the Approved for Interview stage.

The three values for the Candidates Being Vetted field may be: “Blank,” “X of Y pending,” and “Complete.” If the process has not gotten to this point, the field may read “Blank.” Otherwise, the values of this field may have values identical to those described above with respect to the Approval stage. As previously described, these options may be hyperlinked to a report with all candidates listed. Since candidates are approved as they are reviewed it is possible to have candidates in the Approved for Interview stage and still have Candidates remaining in the Candidates Presented stage.

The third stage is the Approved for Interview stage, and it is followed by the Candidate Interviewed, Candidate Chosen, and On Boarding stages respectfully. Each of these stages may have one or more clients performing the functions of this stage. Additionally, some clients may have a role in more than one of these stages. At each stage the candidates may approved and automatically moved to the next stage, or they may be rejected (per the Candidate Review feedback form).

In certain embodiments, one or more “Nudge” buttons may be situated within an “X of Y pending” report which may be reached via a hyperlink in the corresponding stage field. When clicked the “Nudge” button(s) may automatically send a pre-configured message to the next person responsible to act on the requirement. For example, if a second Approver has had the requirement for a few days and the Hiring Manager wants to remind them to review it, the Hiring Manager may click the Nudge button and a message is sent to the second Approver asking them to act. In certain embodiments, the “Nudge” functionality may only be available to those users defined as Hiring Managers, Submitters, Account administrator on the given Requirement.

Throughout the VETTEX system, there may be cross references to different types of data. To make navigation easier hyperlinks to the underlying data may be included. For example, References to Resource/Candidates on any screen may hyperlink to their Resource Summary screen, while references to Requirements or Job ID may hyperlink to the Requirement Summary screen. Additionally, history buttons (as linked to Requirements or Resources) may Pop-up a chronologic list of all Notices (Alerts and Notifications) related to that Item. In certain embodiments, the “Nudge” buttons may bring up a text box so the user can type a message to the recipient. This may appear as a Pop-up window so that the active screen does not change. Furthermore, embodiments may include buttons allowing the user to respond to the request without logging in. Exemplary candidates for this may be requests for small amounts of data entry or Yes/No or Accept/Reject requests.

### Entitlement

The Vettex System is designed to minimize the number of Entitlement tables and settings. However there are some broad differences in functionality and user Roles that require broad Entitlement rules. Generally, there are two different types of Entitlement rules in the VETTEX system: Functional Entitlement and Data Entitlement.

Functional Entitlement rules apply when a user's Role requires access (or limited access) to core Vettex screens, functionality, or fields. The user Role types are defined below.

Embodiments of the VETTEX system deploy Functional Entitlements by either flags of the user's Role type on a master user table or Physically segregating user tables by Role type and/or by Account. Through either deployment, however, there is at least one field that defines a user's Functional Role, and that Role in turn controls the user's Vettex experience.

There are certain user Roles that require access (or limited access) to entire screens. For example, vendors will never submit a Requirement into Vettex and therefore do not need access to the Requirement Wizard. Additionally, there are field-specific functional requirements that are applied at the field level within a screen all users can see. For example, a Resource Information screen may include Social Security Number, visible to the Account Administrator/Recruiter and the Vendor who submitted the resource but not to the client. In this case the design of the Resource Information screen would be the same regardless of the user, but the contents of the SSN field would contain the word “Restricted”. In some embodiments, the Data Entitlement restrictions populate the Entitled field with the word Restricted.

As stated above, certain user's Role requires access (or limited access) to core Vettex screens, functionality, or fields. For example, the role of Vettex Administrator may have access to all information across all Accounts and ability to segregate information by Account, while the Account Administrator/Recruiter may have access to all Requirement and Resource information for their assigned Account(s). Moreover, clients may be divided into subtypes (e.g., Submitter, Hiring Manager, Reviewer, Interviewer) which may limit access to certain submitted Requirements, access to the status on Requirements submitted, the ability to find and assess resources. Additional roles may also include: vendors, HR, and resources.

Embodiments of the present disclosure generally include the use of databases which may be stored on one or more pieces of hardware located at the physical location of one or more accounts, at Vettex home offices, or any other location beneficial to the operation of the VETTEX system. In some embodiments there may be three or more different types of information stored in the VETTEX system. For example, embodiments may include a Requirement Database/Tables for referencing and feeding from the Job Requirement Wizard screens and front end, a Resource Database/Tables for referencing the Resource Front end, as fed from the Resource Wizard Submission Process. Specifically, there may be two types of Resource tables. There may be an Enterprise Resource Database (called ERD for short) including one Enterprise-level Vettex Resource database with all Resources available in Vettex for all Accounts. There may also be a Client Resource Database wherein the Resources are a subset of the Enterprise Database, and are assigned to certain Accounts and Vendors (assumed) through a flag on the Enterprise database.

Information and signals may be represented using any of a variety of different technologies and techniques. For example, data, instructions, commands, information, signals and the like that may be referenced throughout the above description may be represented by voltages, currents, electromagnetic waves, magnetic fields or particles, optical fields or particles or any combination thereof.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device, discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core or any other such configuration.

The steps of a method or algorithm described in connection with the present disclosure may be embodied directly in hardware, in a software module executed by a processor or in a combination of the two. A software module may reside in any form of storage medium that is known in the art. Some examples of storage media that may be used include RAM memory, flash memory, ROM memory, EPROM memory, EEPROM memory, registers, a hard disk, a removable disk, a CD-ROM and so forth. A software module may comprise a single instruction, or many instructions, and may be distributed over several different code segments, among different programs and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in software, the functions may be stored as one or more instructions on a computer-readable medium. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray® disc where disks usually reproduce data magnetically, while discs reproduce data optically with lasers.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein, such as those illustrated in the Figures, can be downloaded and/or otherwise obtained by a mobile device and/or base station as applicable. For example, such a device can be coupled to a server to facilitate the transfer of means for performing the methods described herein. Alternatively, various methods described herein can be provided via a storage means (e.g., random access memory (RAM), read only memory (ROM), a physical storage medium such as a compact disc (CD) or floppy disk, etc.), such that a mobile device and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims

While the foregoing is directed to embodiments of the present disclosure, other and further embodiments of the disclosure may be devised without departing from the basic scope thereof, and the scope thereof is determined by the claims that follow.

1. An automation system for managing workflows associated with matching employment requirements and employment candidates, comprising:
a set of databases;
a user interface allowing:
a first user to create an employment requirement listing one or more qualifications for the requirement and store the requirement in a first database of the set of databases,
a second user, physically separated from the first user, the ability to approve the employment requirement,
a separate and distinct set of users, physically separated from the first and second users, the ability to enter data reflecting skills and qualifications and store it in a second database of the set of databases, and
a third user the ability to search the first and second databases in an attempt to match one or more members of the separate and distinct set of users with at least one of the one or more qualifications of the employment requirement; and
a communication protocol allowing the third user to communicate with any of the first user, second user, and separate and distinct set of users.
